(19) United States
(12) Patent Application Publication
(10) Pub. No.: US 2008/0281754 A1
(43) Pub. Date: Nov. 13, 2008

(54) SYSTEMS AND METHODS FOR FACILITATING AFFILIATE-BASED TRANSACTIONS

(76) Inventors: Sean W. Kelley, Seattle, WA (US); Brendyn W. Alexander, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/747,642

(22) Filed: May 11, 2007

(51) Int. Cl. G06Q 30/00; G06F 15/00; G06F 15/16; G06F 17/00; G06F 17/30; G06F 17/40

(52) U.S. Cl. 705/39; 705/1; 707/104.1; 709/203; 707/E17.005; 715/205

(57) ABSTRACT

Enhanced methods, systems, and techniques for facilitating affiliate-based transactions are provided. Example embodiments provide an Affiliation Facilitator System, which generates and provides reference rewriter code modules based on affiliations between content providers and target sites. In some embodiments, a reference rewriter code may execute on a client computing system to automatically modify content provided by a content provider that is affiliated with one or more target sites. In some cases, the reference rewriter code may modify links that refer to designated target sites to refer instead to designated affiliation facilitators. The designated affiliation facilitators may then track accesses to the target sites and provide compensation to the content provider based on the tracked accesses. This abstract is provided to comply with rules requiring an abstract, and is submitted with the intention that it will not be used to interpret or limit the scope or meaning of the claims.

### TECHNICAL FIELD

The present disclosure relates to methods and systems for facilitating affiliate-based transactions and, in particular, to methods and systems for client-side modification of content having links that refer to designated target sites to refer instead to designated affiliation facilitators.

### BACKGROUND

A number of approaches exist for promoting commerce on the Internet. In one approach, an affiliate of a merchant Web site, such as an online store, may be rewarded for driving user traffic to the merchant Web site. Typically, affiliates are operators of Web sites that provide information to users, such as in the form of Web pages provided by a Web server to client computing devices operated by those users. In one example affiliate arrangement, a particular Web page provided by an affiliate Web site to a client computing device may include one or more hyperlinks directed to various merchant Web sites for example, to purchase a product related to content on the Web site. Then, when the user of the client computing device selects one of those hyperlinks to access the merchant Web site, the access is logged and associated with the affiliate Web site for purposes of compensation. In some cases, accesses may be logged by the merchant Web site. In other situations, accesses may be logged by an intermediary service (e.g., an advertising agency) associated with the merchant, where the affiliate Web site, instead of including hyperlinks directly to the merchant Web site, includes hyperlinks to the intermediary service. In addition, accesses may be characterized into different types, so as to provide differential rewards for different types of accesses. For example, an access that results in a purchase or other customer acquisition at a merchant Web site may be rewarded more highly than a simple access for information. Various models have been proposed and/or utilized, including Pay Per Impression, Pay Per Click, Pay Per Sale, Pay Per Customer Acquisition, etc.

The above approach suffers from various drawbacks. First, operators of affiliate Web sites may be required to update any hyperlinks to merchant Web sites with which they are affiliated. In particular, this may include performing server-side modifications to all or a portion of the hyperlinks that refer to merchant Web sites that are stored in Web pages on a server operated or utilized by the affiliate Web site. For example, the affiliate Web operator may be required to change all hyperlinks that refer to a particular merchant site to refer instead to an intermediary access logging service, so that accesses originating from those Web pages can be logged for purposes of compensation. Affiliate Web sites that provide many Web pages may experience difficulties performing large-scale, bulk updates of their Web pages. In some cases, this may require identifying hundreds or even thousands of files located on a Web server and editing or modifying such files to appropriately modify all hyperlinks that refer to merchant Web sites. In addition, as many Web pages are dynamically generated based on the contents of other stored information (e.g., in a database), performing such updates in a uniform and large-scale manner may be technically complex.

Furthermore, the need to modify or update hyperlinks distributed over large collections of Web pages may effectively exclude or diminish the participation of less technically sophisticated authors of Web pages (e.g., blog authors) in affiliate programs, because those authors may not operate their own Web servers and hence may not be capable of efficiently traversing a file tree or accessing a database that is used to represent their Web pages. In addition, performing bulk changes to large collections of Web pages may render such Web pages unusable in the face of changes to the intermediary services utilized to log accesses. For example, should the name, address, and/or interface to such a service change, hyperlinks from existing Web pages may become “broken” in that they refer to logging services that are no longer operative, thereby damaging the user experience of clients who attempt to follow such hyperlinks.

### BRIEF DESCRIPTION OF THE DRAWINGS

FIG. 1 is an example block diagram of components of an example environment for facilitating affiliate-based transactions using an Affiliation Facilitator System.

FIG. 2 is an example block diagram depicting interactions between example components of an example Affiliation Facilitator System.

FIGS. 3A-3C are example block diagrams depicting an example stylized DOM (“Document Object Model”) tree produced by a Web browser and modified by code generated by an example embodiment of an Affiliation Facilitator System.

FIG. 4 is an example block diagram of a general purpose computer system for practicing embodiments of an Affiliation Facilitator System.

FIG. 5 is an example flow diagram of an example reference rewriter provider routine provided by an example embodiment of an Affiliation Facilitator System.

FIG. 6 is an example flow diagram of an example reference rewriter routine generated and provided by an example embodiment of an Affiliation Facilitation System.

### DETAILED DESCRIPTION

Embodiments described herein provide enhanced computer- and network-based techniques for facilitating affiliate-based transactions. In some embodiments, the techniques include generating and providing reference rewriter code configured, when executed on a client computing device, to cause the client computing device to automatically modify links in content that refer to designated target sites (e.g., network-accessible merchants, advertisers, stores, etc.) to refer instead to designated affiliation facilitators or other systems configured to track accesses to the designated target sites. In some embodiments, such reference rewriter code may be included (e.g., by content providers or other parties and/or systems) in content (e.g., documents, files, streams, etc.) that may contain links to one or more designated target sites, such that when the content is received, rendered, presented, or otherwise processed by a client device (e.g., a computer executing a browser application, a news reader, a mail reader, etc.), the designated target site links are automatically modified to refer instead to corresponding affiliation facilitators. Then, when one of the links is chosen, selected, followed, or otherwise indicated by a user or other agent, a request or other access is made to the corresponding affiliation facilitator instead of the designated target site. The corresponding affiliation facilitator may then track, record, process, or otherwise monitor accesses to the designated target site. In such a manner, the described techniques provide convenient, flexible, dynamic client-side functionality to allow content providers to participate in affiliate marketing programs and/or networks without having to statically rewrite or modify existing content.

In some embodiments, some of the described techniques are performed by an Affiliation Facilitator System (“AFS”). The AFS may automatically generate reference rewriter code based on information about affiliate memberships, relationships, and/or accounts held by content providers. Content providers may include entities (e.g., persons, organizations, corporations, etc.) that generate (e.g., produce, write, create, etc.) content such as authors, bloggers, artists, reviewers, news organizations, etc. In addition, content providers may include entities that distribute (e.g., provide, send, transmit, host) content, such as Web hosting services, blog hosting services, social networking sites, message board operators, etc. The AFS may also provide indications of the generated reference rewriter code to the content providers for use in their provided content. In addition, the AFS may cause or otherwise initiate the execution on a client device of the generated reference rewriter code by directly providing the code to a client device that renders or otherwise processes the content provided by the content providers. Furthermore, the AFS may perform various functions related to tracking accesses to target sites identified as being affiliated with some other entity and/or service (e.g., the content provider, an AFS, etc.), managing affiliation accounts held by content providers and/or target sites, matching content providers with affiliate programs that are suitable for their type and/or volume of content, establishing affiliate programs for target sites based on their type of commerce and/or advertising, and managing transactions between content providers and target sites (e.g., payments from merchants and/or advertisers who operate target sites).

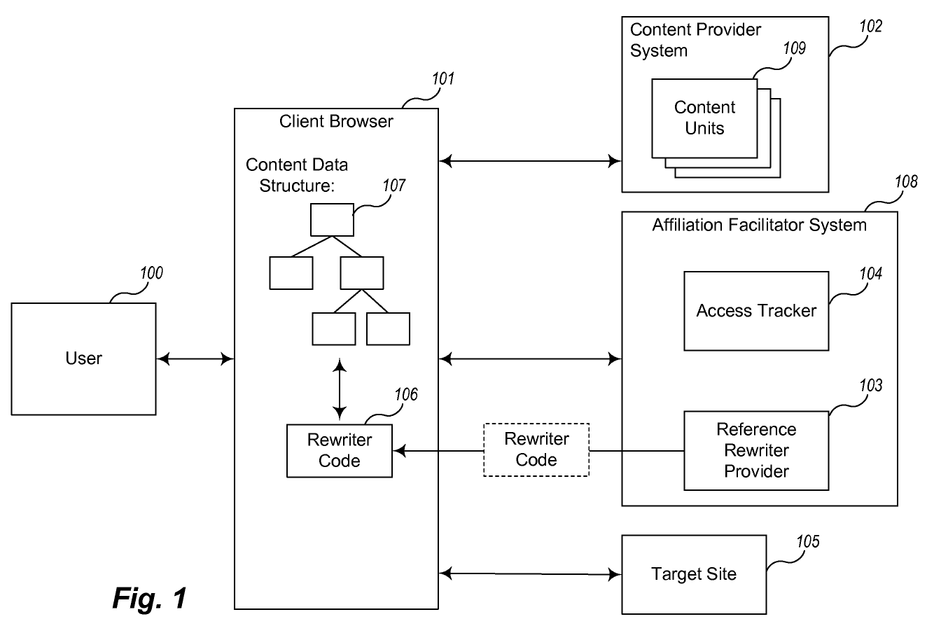

FIG. 1 is an example block diagram of components of an example environment for facilitating affiliate-based transactions using an Affiliation Facilitator System. In particular, FIG. 1 depicts the facilitation of affiliate-based transactions in the context of a user 100 operating a client browser 101. The client browser 101 may be, for example, a Web browser or other application capable of obtaining, processing, and rendering (e.g., presenting, displaying) units of content that may refer to other units of content. Content units may be organized, provided, and/or implemented in various ways, such as in documents, files, pages, messages, packets, and/or streams, and may contain information and/or instructions that may be interpreted, executed, or otherwise processed by the client browser in order to display or otherwise present the content to a user or other agent. A content unit may also include one or more links that each refer to other content units. The client browser 101 may render links in an identifying manner (e.g., by underlining, bolding, coloring, presenting as a button, playing an audio clip, etc.). A user may select a link in order to indicate that the client browser 101 should obtain and render the underlying content unit that is the referent of the selected link. In the illustrated embodiment, the content units are Web pages that include HTML (“Hypertext Markup Language”) instructions that may be rendered by the client browser 101. In addition, links are implemented by way of HTML anchor tags (i.e., “A” tag) that include references represented by way of URLs (“Uniform Resource Locators”) and/or URIs (“Uniform Resource Identifiers”). Furthermore, content units are hosted by network-accessible computing systems executing Web servers.

In the illustrated example, a user 100 operates a client browser 101 to obtain content (e.g., a Web page containing HTML instructions) from a content provider system 102. The content provider system 102 may be a network-accessible computing system executing a Web or other server capable of providing content units in response to a request from a client application such as client browser 101. The illustrated content provider system 102 provides content for an entity (e.g., person, business organization, etc.) that is affiliated with a target site 105. The affiliated entity may in some embodiments be the operator of the content provider system 102 that provides content, for example, one or more of content units 109, generated by the affiliated entity and/or other parties (e.g., by hosting a blogging system, a newsgroup, a discussion board, etc.). In other embodiments, the affiliated entity may be a person or organization who does not operate the content provider system 102, but instead generates the content for example, one or more of the content units 109, (e.g., in the form of a blog, journal, newsletter, etc.) that is hosted by content provider system 102. By virtue of an affiliation with the target site 105, the affiliated entity potentially earns compensation from the target site 105, based on accesses to the target site 105 generated by one or more of the content units 109.

In the illustrated example, the one or more content units 109 provided by the content provider system 102 include an indication to reference rewriter code 106 that is provided by a reference rewriter provider component 103 of an affiliation facilitator system 108 to the client browser 101 when the content units are rendered. The reference rewriter code 106 is configured, when executed by the client browser 101, to automatically modify any links in the one or more content units that refer to the target site 105 to refer instead to an access tracker component 104 of the affiliation facilitator system 108.

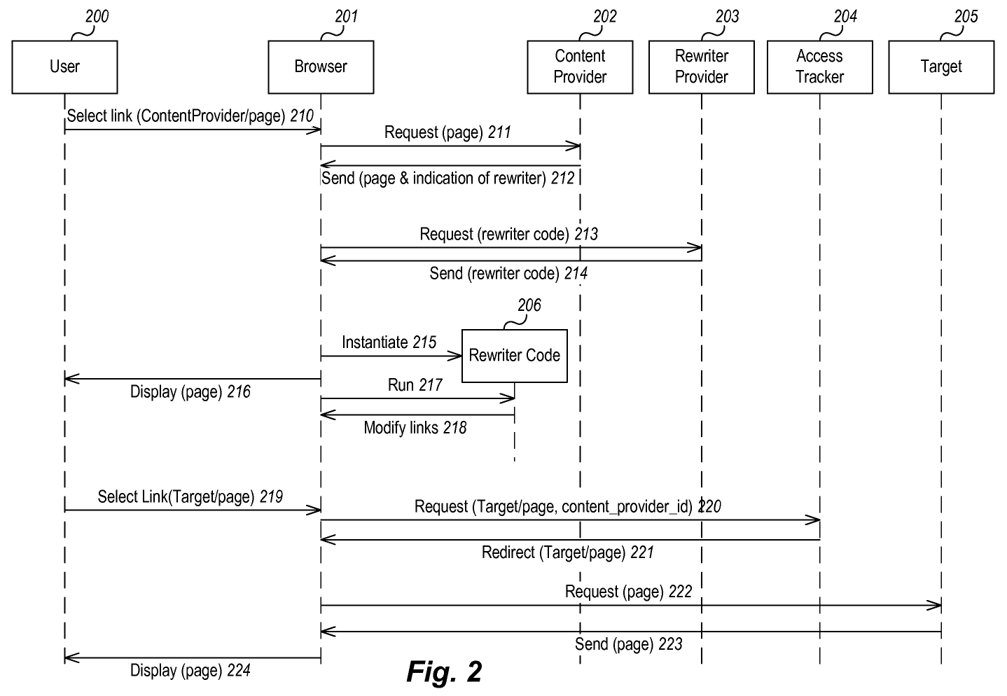

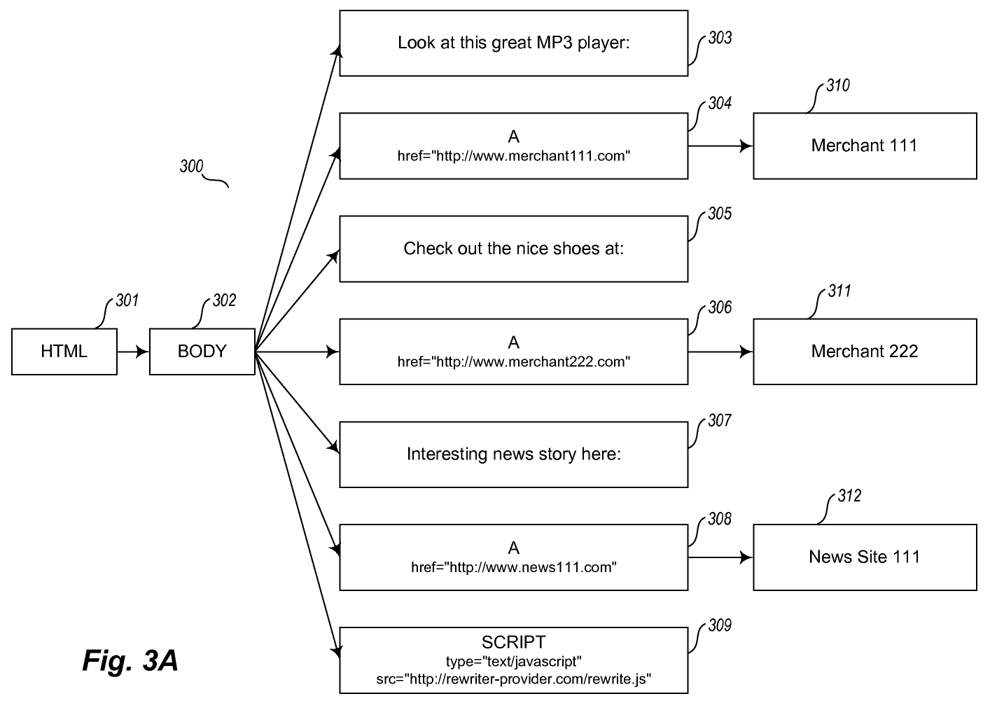

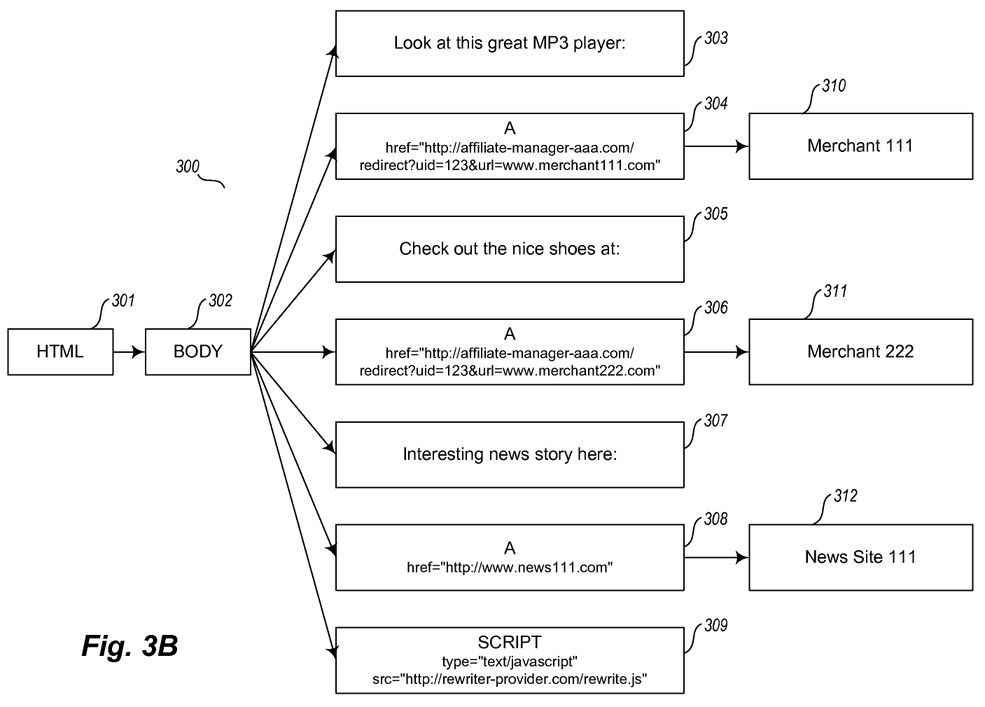

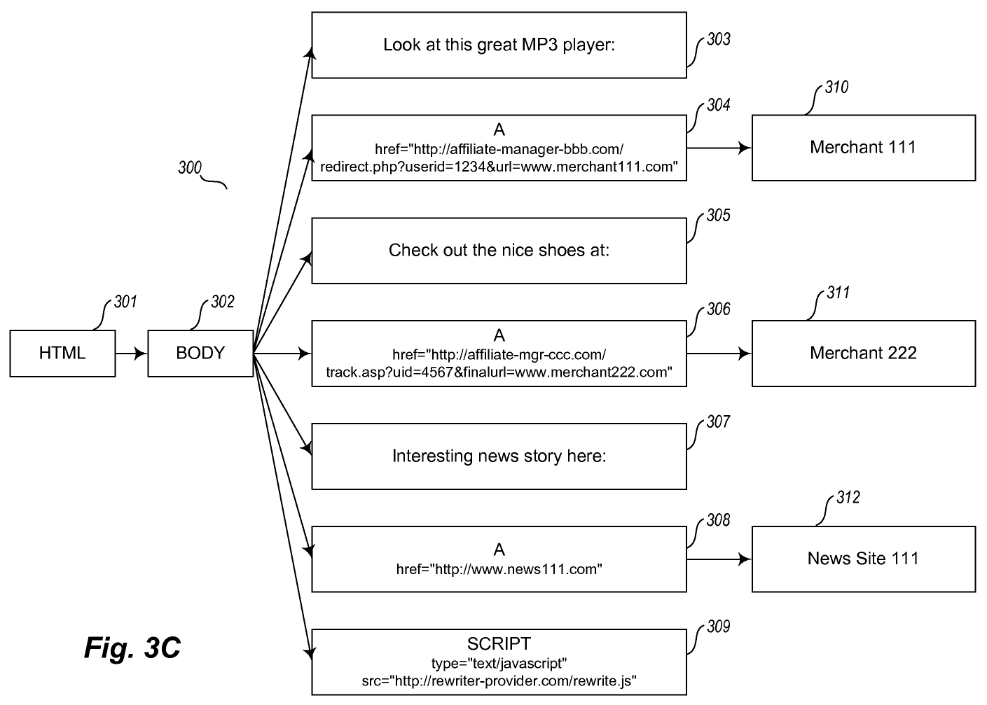

In a typical interaction, the data and communications flow proceeds as follows. When the user 100 operates the client browser 101 to obtain, for example, a Web page from content provider 102, the Web page, such as one of the content units 109, is forwarded from the content provider system 102 to the client browser 101 and processed to generate a corresponding data structure 107, such as a DOM (“Document Object Model”) tree, that reflects the obtained Web page. In addition, the obtained Web page includes an indication to reference rewriter code 106 that is automatically fetched by the client browser 101 from the reference rewriter provider 103 and instantiated as rewriter code 106 as explained below with regard to FIGS. 2 and 3A-3C. The rewriter code 106 is run and processes any links found in the data structure 107 that refer to the target site 105 in order to modify such links to refer instead to the access tracker 104. Then, when the user 100 selects one of the modified links, the client browser 101 forwards a request to the access tracker 104. The access tracker then performs one or more operations to track an access to the target site 105 (e.g., records, processes, notes, and/or logs the access) and then causes the client browser 101 to automatically forward a request to the original target site 105 (e.g., by responding with an HTTP redirection code to the target site 105).

In the illustrated embodiment, the reference rewriter code 106 is provided by the reference rewriter provider module 103, which is a component of the affiliation facilitator system 108. In other embodiments, the reference rewriter code 106 may be provided by other modules and/or systems, such as the content provider system 102 or a third-party computing system (not shown) that may or may not be associated with the affiliation facilitator system 108.

FIG. 2 is an example block diagram depicting interactions between example components of an example Affiliation Facilitator System. The interactions are depicted over time, such that the earlier activities occur nearer the top and the later occur near the bottom. The illustrated components include a user 200, a browser 201, a content provider 202, a rewriter provider 203, an access tracker 204, and a target site 205. These elements are similar to those described with reference to FIG. 1, except that in this embodiment, the rewriter provider 203 and the access tracker 204 are not integrated into a single Affiliation Facilitator System. Such a situation may exist, for example, when the rewriter provider 203 and the access tracker 204 are operated by different entities, such as when a first entity operates the rewriter provider 203 to provide reference rewriter code modules to various affiliation facilitators. In such cases, the rewriter provider 203 may provide rewriter code for one or more affiliation facilitators that track accesses to various content providers, possibly in exchange for a fee from the affiliation facilitator that operates the access tracker 204 and/or from the content providers 202 themselves.

FIG. 2 illustrates communication between users/components 200-206 as interactions 210-224. The interactions 210-224 are labeled with text describing a message, operation, invocation, request and/or response traveling between the illustrated users/components 200-206. In the illustrated example, the user 200 selects a link 210 on a Web page (e.g., by clicking on the link with a pointing device) displayed by browser 201 that refers to a content page provided by content provider 202. In other embodiments, users may designate a URL or other resource identifiers in other ways, such as by selecting a user interface component (e.g., a button, a menu item, etc.) and/or specifying text in an input field, etc. In response, the browser 201 sends a request 211 for the content page to the content provider 202. In this embodiment, the request 211 is made in accordance with HTTP (“Hypertext Transport Protocol”) for example, via an HTTP “GET” or “POST” request. In response to the received request, the content provider 202 sends a response 212 (e.g., an HTTP response) that includes data and instructions associated with the Web page (e.g., in HTML format).

The provided Web page of response 212 also includes a reference to rewriter code to be executed by the browser 201 to rewrite links that refer to target sites to refer instead to designated affiliate sites. The browser 201 then processes (e.g., parses) the Web page and generates one or more data structures (e.g., a DOM tree) reflecting the provided Web page. In the illustrated example, the included reference to rewriter code is implemented via an HTML SCRIPT tag that includes a reference (e.g., a URL) indicating the location of the reference rewriter code. When the browser 201 processes the SCRIPT tag, it automatically makes a request 213 to the rewriter provider 203 for the indicated reference rewriter code. In response to the received request 213, the rewriter provider 203 sends a response 214 that includes the indicated reference rewriter code. Once the indicated reference rewriter code is received by the browser 201, the browser 201 instantiates 215 a reference rewriter code module 206 (e.g., by parsing the code and creating an in-memory data structure representing the instructions and/or data included in the code). Then, the browser 201 displays the Web page 216 to the user 200. Next, the browser 201 runs 217 (e.g., initiates execution on the code module 206. The reference rewriter code module 206 then automatically modifies links 218 in the Web page that refer to designated target sites, such as by automatically obtaining and modifying links from a data structure (e.g., a DOM tree) that represents the Web page.

Later, the user 200 selects a link 219 on the displayed Web page that the user sees as referring to a Web page hosted by target site 205. As noted above, all links referring to the target site 205 have been automatically rewritten by the reference rewriter code module 206 to refer instead to the access tracker 204. Accordingly, the browser 201 sends a request 220 to the access tracker 204. In the illustrated embodiment, the request includes an indication of the Web page hosted by the target site 205, as well as an indication of the content provider 202 that initially provided the Web page having a reference to the target site (e.g., a “content_provider_id”). With this information, the access tracker 204 can record that the target site 205 is being accessed, and that the access is originating from a Web page provided by a content provider (e.g., content provider 202) that is affiliated with the target site 205. The access tracker 204 may also perform various other functions at this time, such as initiating the tracking of future accesses, such as by setting one or more HTTP cookies on the browser 201, such that future accesses or operations may be associated with the content provider 202 and/or the access tracker 204.

After recording the access, the access tracker 204 responds with a redirect response 221 to the target site. Redirects may be provided in various ways, such as via the HTTP Redirect mechanism (e.g., by responding with the appropriate redirection response code), to instruct the browser 201 to automatically initiate a request to the target site 205. In response to the received redirect response 221, the browser 201 automatically sends a request 222 to the target site 205, the request including an indication of a content page. In response to the received request 222, the target site sends a response 223 that includes data and instructions associated with the Web page. Upon receiving the response 223, the browser 201 processes and renders the received page, and displays the page 224 to the user. In this manner, the interaction between the browser 201 and the access tracker 204 occurs transparently to the user, such that the user will typically be unaware that their selection of a link referring to the target site did not actually directly access the target site, and instead was redirected via the access tracker 204.

In the illustrated embodiment, accesses to target sites are first tracked by an access tracker and then redirected to the target site. In other embodiments, accesses may instead go directly to the target site, without first being tracked by an access tracker. In such embodiments, reference rewriter code may still be employed to modify links that refer to designated target sites, such that the modified links include some indication of the content provider that initially provided the content, such that the target site may track accesses and attribute those accesses to various content providers. Information related to the tracked accesses (e.g., counts, statistics, etc.) may then be periodically or upon request provided to one or more affiliation facilitators for purposes of providing compensation to content providers. Such an approach may be advantageous when accesses to access trackers are blocked, for example, by filtering systems configured to restrict and/or allow accesses only to specified Web sites (e.g., advertising blockers, firewalls, Web filters, etc.).

Although the described techniques and systems are described with reference to facilitating affiliate-based transactions, one will recognize that the described techniques are generally applicable in other contexts as well. In general, the described techniques can be used to perform transparent, client-side modification of links and/or references for other purposes, such as supporting document migration (e.g., to correct “stale” references to documents that have been moved or otherwise relocated to new locations), document usage tracking (e.g., on an intranet), Web monitoring and/or filtering (e.g., to block and/or redirect accesses to potentially offensive Web sites), etc.

In addition, even though at least some of the described embodiments are implemented in terms of intercommunicating Web browsers and Web servers using the HTTP protocol as a transport mechanism, HTML as a content language, and JavaScript to implement rewriter code modules, other implementation schemes are equally applicable. For example, the described techniques may be implemented in any content representation language or format that supports inter- or intra-document hyperlinks, such as XHTML, XML (“Extensible Markup Language”), Microsoft Word format, etc. In addition, rewriter code modules may be implemented in any programming language and/or instructions supported by a client browser application and/or system runtime, such as VBScript, Visual Basic, ActionScript, Java, C#, C++, C, Java Virtual Machine instructions, Common Language Runtime instructions, etc. Furthermore, alternative communication mechanisms and/or protocols aside from or in addition to HTTP may be utilized, such as HTTPS, FTP, TELNET, TCP/IP, UDP, etc. Also, the described techniques may be utilized by client systems other than Web browsers, such as document preparation systems (e.g., word processors, text editors, mail readers, image editors, etc.).

FIGS. 3A-3C are example block diagrams depicting an example stylized DOM (“Document Object Model”) tree produced by a Web browser and modified by code generated by an example embodiment of an Affiliation Facilitator System. In particular, FIG. 3A depicts a DOM tree corresponding to the HTML segment shown in Table 1, below. FIG. 3B depicts the DOM tree of FIG. 3A after it has been processed and modified by an example reference rewriter code module, shown in Table 2, below. FIG. 3C depicts the DOM tree of FIG. 3A after it has been processed by an alternative example reference rewriter code module shown in Table 3, below.

Table 1 illustrates an example HTML segment that is provided by an example content provider to a Web browser (e.g., content provider 102 to Web browser 101 of FIG. 1). This HTML segment, when rendered by the Web browser, shows three segments of text, each followed by a link to a Web site. The example content provider is affiliated with two target sites operated by Merchant 111 and Merchant 222, respectively. Line 5 shows a link having a reference to a target site operated by or for merchant 111. Similarly, line 8 shows a link having a reference to a target site operated by or for merchant 222. Lines 13-14 illustrate use of a SCRIPT tag to include a reference to the reference rewriter code.

TABLE 1

| | |
|---|---|
| 1. | <HTML> |
| 2. | <BODY> |
| 3. | |
| 4. | Look at this great MP3 player: |
| 5. | <A href=“http://www.merchant111.com”>Merchant 111</A> |
| 6. | |
| 7. | Check out the nice shoes at: |
| 8. | <A href=“http://www.merchant222.com”>Merchant 222</A> |
| 9. | |
| 10. | Interesting news story here: |
| 11. | <A href=“http://www.news111.com”>News Site 111</A> |
| 12. | |
| 13. | <SCRIPT type=“text/javascript” |
| 14. | src=“http://rewriter-provider.com/rewrite.js”> </SCRIPT> |
| 15. | </BODY> |
| 16. | </HTML> |

FIG. 3A depicts a DOM tree 300 comprising a root node 301, corresponding to the HTML element specified starting at line 1 and ending at line 16 of Table 1. The root node 301 has a single child node 302, corresponding to the BODY element specified starting at line 2 and ending at line 15 of Table 1. Node 302 has seven child nodes 303-309, corresponding respectively to the text specified on line 4, the A element specified on line 5, the text specified on line 7, the A element specified on line 8, the text specified on line 10, the A element specified on line 11, and the SCRIPT element specified on lines 13-14, respectively. The A elements (“Anchor” elements) represented by nodes 304, 306, and 308 specify HTML links that refer to various target sites associated with merchant 111, merchant 222, and news site 111, respectively. In addition, node 304 has a single child node 310 corresponding to the text specified as part of the A element specified on line 5. Node 306 has a single child node 311 corresponding to the text specified as part of the A element specified on line 7. Node 308 has a single child node 312 corresponding to the text specified as part of the A element specified on line 10. In addition, the SCRIPT element includes an indication of a rewriter code module via the “src” attribute associated with the element. This attribute may be used to provide a URL that indicates a source location (e.g., http://rewriter-provider.com/rewrite.js) from which the rewriter code may be obtained. In other embodiments, the code may be included verbatim as part of the SCRIPT element of the HTML segment shown in Table 1. In addition, other HTML elements, such as an OBJECT element, could be used to include an indication of a reference rewriter code module.

Table 2 depicts an example reference rewriter code segment referenced by the SCRIPT element of the HTML segment of Table 1. In a typical embodiment, as described with reference to FIGS. 1 and 2, the following code segment is automatically loaded, parsed, and executed by the Web browser that processes the HTML segment of Table 1.

TABLE 2

| | |
|---|---|
| 1. | function modify_links( ) { |
| 2. | |
| 3. | var regex = |
| 4. | /(http:\/\/www.merchant111.com\|http:\/\/www.merchant222.com)/i; |
| 5. | var anchors = document.links; |
| 6. | |
| 7. | for (var i = 0; 1 < anchors.length; i++) { |
| 8. | if (regex.test(anchors[i].href)) { |
| 9. | var prevtext = anchors[i].innerText; |
| 10. | anchors[i].href = |
| 11. | “http://affiliate-manager-aaa.com/redirect?uid=123&url=” + |
| 12. | anchors[i].href; |
| 13. | anchors[i].innerText = prevtext; |
| 14. | } |
| 15. | } |
| 16. | |
| 17. | } |
| 18. | document.onload = modify_links( ); |

The code segment of Table 2 specifies a function called “modify_links” at lines 1-17. Lines 3-4 specify a regular expression that designates two references to target sites (e.g., http://www.merchant111.com and http://www.merchant222.com) that are to be rewritten by the function to refer instead to a designated affiliation facilitator. In line 5, the a collection of all of the links of the current document DOM tree (e.g., DOM tree 300) is bound to a variable named “anchors.” In lines 7-15, the function iterates over the collection of links, testing each link (at line 8) to determine whether it refers to one of the designated target sites designated by the regular expression. If so, the code specified from lines 9-13 substitutes for the original link reference to the designated target site a reference instead to a designated affiliation facilitator (e.g., http://affiliate-manager-aaa.com/redirect?uid=123&url=) that is concatenated with the original link reference to the designated target site. In one embodiment, the reference to the designated affiliation facilitator includes arguments that identify a user account associated with the content provider (e.g., “uid”) and the original reference to the designated target site (e.g., “url”). The original reference to the target site is passed to the affiliation facilitator so that the affiliation facilitator can properly redirect the Web browser access to the designated target site after the affiliation facilitator has recorded or otherwise tracked the access. The identification of the user account associated with the content provider is passed to the affiliation facilitator so that the affiliation facilitator can attribute the access to the designated target site to that content provider (e.g., for purposes of compensating the content provider). At line 18, the modify_links function of lines 1-17 is registered as an event handler to be invoked by the Web browser upon the loading of the HTML segment of Table 1.

FIG. 3B depicts the DOM tree of FIG. 3A after it has been processed by the reference rewriter code module of Table 2. The illustrated DOM tree is the same as that depicted in FIG. 3A, except that attributes associated with nodes 304 and 306 have been modified by the operation of the reference rewriter function specified in Table 2. In particular, in FIG. 3A, the link node 304 includes a reference to target site www.merchant111.com, whereas in FIG. 3B, the link node 304 now includes a reference to affiliate-manager-aaa.com/redirect?uid=123&url=www.merchant111.com, which is a reference to the designated affiliation facilitator specified by the code segment of Table 2 together with an indication of a user associated with the content provider of the Web page illustrated in Table 1, above, as well as an indication of the target site www.merchant111.com. Similarly, in FIG. 3A, the link node 306 includes a reference to target site www.merchant222.com, whereas in FIG. 3B, the link node 304 includes a reference to affiliate-manager-aaa.com/redirect?uid=123&url=www.merchant222.com, which is a reference to the designated affiliation facilitator specified by the code segment of Table 2 together with an indication of a user associated with the content provider of the Web page illustrated in Table 1, above, as well as an indication of the target site www.merchant222.com. Note also that link node 310 is unmodified as between FIG. 3A and FIG. 3B, because that link node did not include a reference to one of the designated target sites.

Given the modified DOM tree shown in FIG. 3B, when a user who is operating a Web browser that has rendered the illustrated DOM tree 300 selects either the link implemented by node 304 or 306, the browser will initially access the indicated affiliation facilitator. The indicated affiliation facilitator will then track the access and then redirect the browser to the indicated target site. In some embodiments, the browser may instead be initially redirected to one or more other intermediate sites, services, and/or systems (e.g., for purposes such as tracking, monitoring, providing advertisements, etc.), one of which ultimately redirects the browser to the indicated target site.

Table 3 depicts an alternative example reference rewriter code segment referenced by the SCRIPT element of the HTML segment of Table 1. This reference rewriter code module differs from that depicted in Table 2 in that it includes a generalized mapping of designated target sites to designated affiliation facilitators, such that references to multiple distinct target sites can be rewritten to refer to multiple distinct affiliation facilitators. Such an approach may be advantageous when an example content provider has affiliation relationships that are managed by multiple affiliation facilitators.

TABLE 3

| | |
|---|---|
| 1. | function modify_links( ) { |
| 2. | var target_urls = [ |
| 3. | “http://www.merchant111.com”, |
| 4. | “http://www.merchant222.com” ]; |
| 5. | var redir_urls = [ |
| 6. | “http://affiliate-mgr-bbb.com/redirect.php?userid=1234&url=”, |
| 7. | “http://affiliate-mgr-ccc.com/track.asp?uid=4567&finalurl=” ]; |
| 8. | var anchors = document.links; |
| 9. | for (var i = 0; i < anchors.length; i++) { |
| 10. | for (var j = 0; j < target_urls.length; j++) { |
| 11. | if (anchors[i].href.match(target_urls[j])) { |
| 12. | var prevtext = anchors[i].innerText; |
| 13. | anchors[i].href = redir_urls[j] + anchors[i].href; |
| 14. | anchors[i].innerText = prevtext; |
| 15. | break; |
| 16. | } |
| 17. | } |
| 18. | } |
| 19. | } |
| 20. | document.onload = modify_links( ); |

The code segment of Table 3 specifies a function called “modify_links” at lines 1-19. Lines 2-4 specify an array of references, “target_urls,” to target sites (e.g., www.merchant111.com and www.merchant222.com) that are to be rewritten by the modify_links function. Lines 5-7 specify an array of references, “redir_urls,” to affiliation facilitators that are each configured to track accesses to corresponding target sites. For example, the first affiliation facilitator specified in the redir_urls array is configured to track accesses to the first target site specified in the target_urls array. In line 8, a collection of all of the links of the current document DOM tree (e.g., DOM tree 300) is bound to a variable named “anchors.” In lines 9-18, the function iterates over the collection of links, testing each link against each element of the target_urls array (at lines 10-17) to determine whether the link refers to one of the designated target sites. If so, the code specified from lines 11-16 substitutes the original link reference to the designated target site with a corresponding reference to a designated affiliation facilitator from the redir_urls array concatenated with the original link reference. As described in more detail with reference to Table 2, the reference to the designated affiliation facilitator includes arguments that identify a user account associated with the content provider and the original reference to the designated target site. The example of Table 3 differs from that of Table 2 in that different protocols or calling conventions associated with different affiliation facilitators may be accommodated. In other embodiments, other approaches may be taken, such as executing arbitrary code (e.g., provided by various affiliation facilitators) to generate an appropriate reference to an affiliation facilitator. At line 20, the modify_links function of lines 1-19 is registered as an event handler to be invoked by the Web browser upon the loading of the document.

FIG. 3C depicts the DOM tree of FIG. 3A after it has been processed by the reference rewriter code module of Table 3. The illustrated DOM tree is the same, except that attributes associated with nodes 304 and 306 have been modified by the operation of the reference rewriter function of Table 3. Note that, in contrast to FIG. 3B and the operation of the reference rewriter function specified in Table 2, nodes 304 and 306 now refer to different affiliation facilitators (e.g., affiliate-mgr-bbb.com and affiliate-mgr-ccc.com, respectively).

Alternative approaches and/or techniques for rewriting references are contemplated. For example, in the embodiments illustrated in Tables 2 and 3, above, an identification of a user account associated with a content provider is added to each modified reference (e.g., as part of a query string), such that the affiliation facilitator can attribute accesses to target sites to the appropriate content provider. However, in other embodiments, the affiliation facilitator may identify content providers in different ways. For example, some networking protocols include a mechanism by which a client application (e.g., a Web browser) may provide information about the origin, basis, history, or context of a request. For instance, a referrer field, such as the HTTP Referer field, may be utilized by an affiliation facilitator to identify the URL of the content provided by the content provider. Based on this URL, the content provider may be identified, and accesses to target sites originating from the provided content may be attributed to the content provider.

In addition, in some embodiments, at least some content providers may not be directly affiliated with any target sites. Instead, some other entity (e.g., an affiliation facilitator, a network provider, etc.) may be affiliated with various target sites. In such circumstances, references may be modified to include an identification of the other entity, such that accesses may be tracked and associated with the other entity (e.g., for purposes of payment, gathering usage statistics, etc.). In some cases, the other entity may share compensation with the content provider.

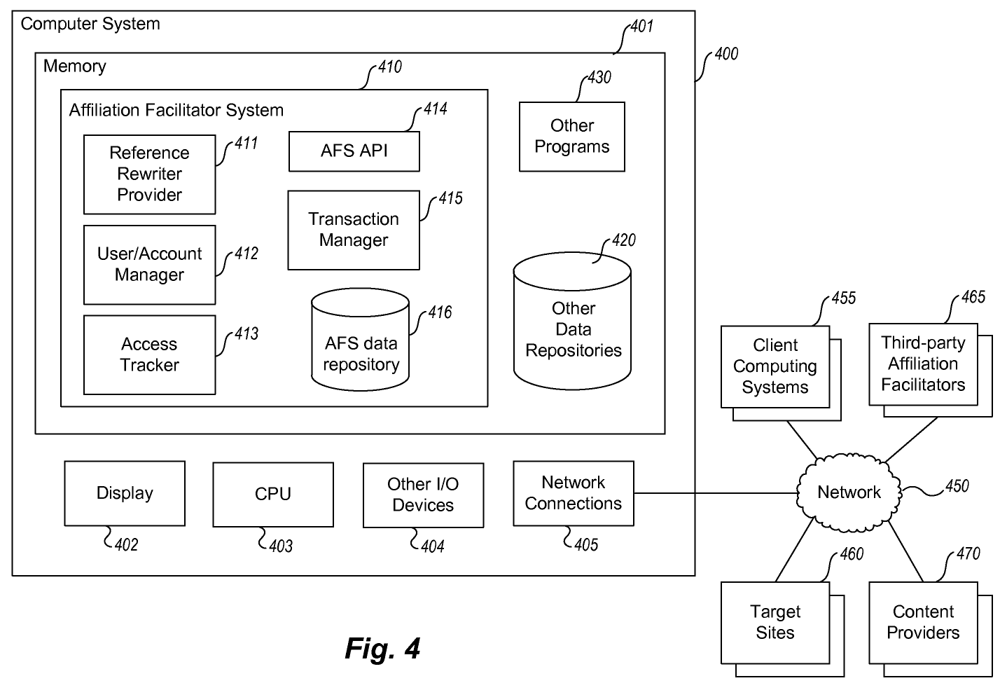

FIG. 4 is an example block diagram of a general purpose computing system for practicing embodiments of an Affiliation Facilitator System. Note that a general purpose or a special purpose computing system may be used to implement an AFS. The general purpose computer system 400 may comprise one or more server and/or client computing systems and may span distributed locations. In addition, each block shown may represent one or more such blocks as appropriate to a specific embodiment or may be combined with other blocks. Moreover, the various blocks of the Affiliation Facilitator System 410 may physically reside on one or more machines, which use standard (e.g., TCP/IP) or proprietary interprocess communication mechanisms to communicate with each other.

In the embodiment shown, computer system 400 comprises a computer memory (“memory”) 401, a display 402, a Central Processing Unit (“CPU”) 403, Input/Output devices 404 (e.g., keyboard, mouse, CRT or LCD display, etc.), and network connections 405. An Affiliation Facilitator System (“AFS”) 410 is shown residing in memory 401. The modules of the AFS 410 preferably execute on CPU 403 and manage affiliations held by various content providers 470 with various target sites 460. Other programs 430 and potentially other data repositories, such as data repository 420, also reside in the memory 401, and preferably execute on one or more CPU's 403. In a typical embodiment, the AFS 410 includes a reference rewriter provider module 411, a user/account manager module 412, an access tracker module 413, an AFS application program interface (“API”) 414, a transaction manager module 415, and an AFS data repository 416. The AFS 410 may interact with client computing systems 455, target sites 460, third-party affiliation facilitators 465, and content providers via a network 450, as described below.

In the illustrated embodiment, the AFS 410 facilitates affiliations between content providers 470 and target sites 460, in order to provide compensation to the content providers 470 based on accesses that are made by users of client computing systems 455 to the target sites 460 and that originate from content provided by the content providers 470. Facilitating affiliations may include, for example, tracking accesses generated by the client computing systems 455 to the target sites 460, and generating reference rewriter code modules for use by content providers 470 and/or third-party affiliation facilitators 465, providing generated reference rewriter code modules for execution on client computing systems 455 in order to cause the automatic modification of links that refer to designated target sites (e.g., one or more of target sites 460) to refer instead to designated affiliation facilitators (e.g., AFS 410 and/or one or more of the third-party affiliation facilitators 465), and/or managing accounts held by content providers 470 and target sites 460 that provide or otherwise participate in affiliate programs (e.g., affiliate advertising/marketing programs). In some embodiments, the AFS 410 may provide a clearinghouse or uniform interface for one or more of the third-party affiliation facilitators 465, such that content providers are provided with a unified account management infrastructure rather than having to interact with multiple, distinct affiliation facilitators.

Note that in some embodiments, the AFS 410 may provide just a subset of the described functionality. In particular, in one embodiment the AFS 410 may provide only services related to generating and providing reference rewriter code modules, as described with reference to the reference rewriter provider module 411. In such cases, the AFS 410 may provide generated reference rewriter code modules to one or more of the third-party affiliation facilitators 465, possibly in exchange for payment. These third-party affiliation facilitators 465 then may be responsible for the access tracking and other services.

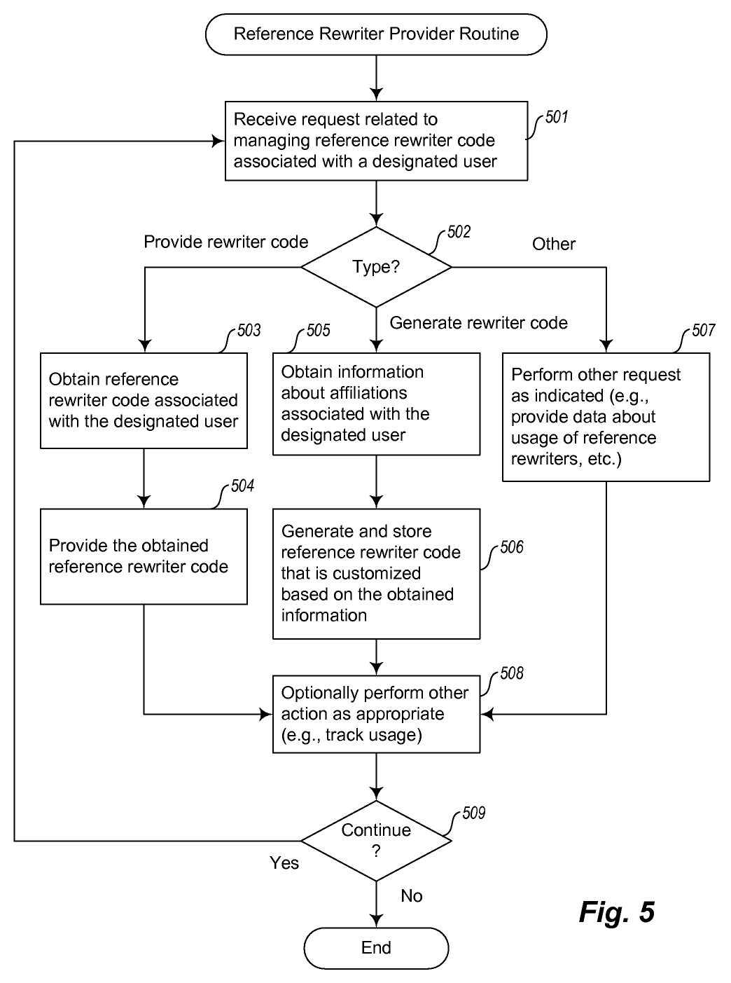

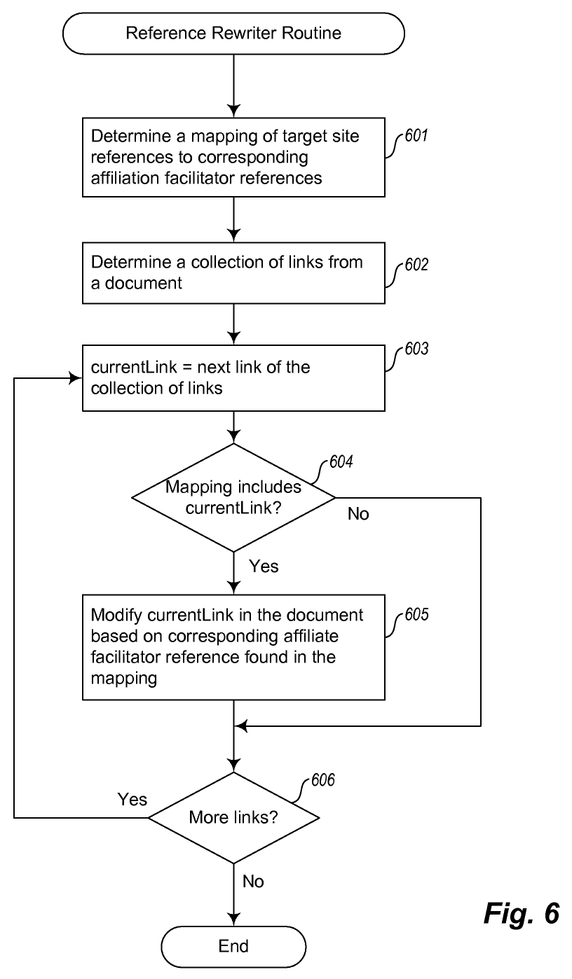

In the illustrated embodiment, the reference rewriter provider module 411 manages production and access to reference rewriter code. In particular, the reference rewriter provider module 411 generates reference rewriter code based on information about affiliations between content providers and target sites. Such information may include indications of references to target sites that are to be rewritten to refer instead to corresponding affiliation facilitators. In addition, such information may include indications of users and/or accounts associated with content providers and/or target sites, such as may be obtained and/or managed by the user/account manager module 412, described in more detail below. Generated reference rewriter code may be stored, for example, in the AFS data repository 416. In addition, the reference rewriter provider module 411 provides generated reference rewriter code in response to requests received from, for example, client computing devices 455 and/or third-party affiliation facilitators 465. Additional details related to the operation of the reference rewriter provider module 411 are described with reference to FIGS. 5 and 6, below.

The user/account manager module 412 manages information about affiliations between content providers and target sites. The user/account manager module 412 may provide functionality for opening, closing, and editing accounts associated with content providers and/ortarget sites. Such accounts may be stored in the AFS data repository 416. For example, one or more of the content providers 470 may open such accounts in order to take part in one or more affiliate programs offered and/or managed by the AFS 410. Information about such accounts may be used by the reference rewriter provider module 411, to generate and/or customize reference rewriter code. In addition, such accounts may be used for purposes of tracking and/or recording accesses to target sites originating with content provided by those content providers. In addition, one or more of the target sites 460 may open such accounts in order to offer or otherwise provide an affiliate program to other content providers. Furthermore, one or more of the third-party affiliation facilitators 465 may open such accounts in order to utilize some or all of the services of the AFS 410 (e.g., tracking accesses, providing reference rewriters, etc.) Such accounts in general may include payment information utilized to obtain payments (e.g., from target sites), and to provide payments (e.g., to content providers), based on the number of tracked accesses originating with or from content provided by affiliated content providers. The user/account manager module 412 may also provide services related to matching content providers with target sites, possibly based on specified criteria. For example, a content provider may browse or search for target sites that are participating in affiliate programs, possibly based on the types or amounts of rewards offered under those affiliate programs. In addition, target sites may search or browse for content providers, possibly based on information about such content providers (e.g., amounts of access traffic generated, etc.).

The access tracker module 413 tracks accesses made by client computing systems 455 to target sites 460 that originate from content provided by content providers 470. Such accesses may include various operations performed by client computing systems 455 with respect to target sites 460, such as impressions (e.g., page views), transactions (e.g., item purchases), customer acquisitions (e.g., new account operations), etc. The access tracker module 413 may record such tracked accesses in the AFS data repository 416 in order to later determine compensation for content providers 470 that originated such accesses. The access tracker may perform such operations transparently, in various ways, such by issuing redirection commands to client computing systems 455 and/or acting as a proxy for target sites 460.

The AFS API 414 provides programmatic access to various features and/or functions of the AFS 410. For example, the AFS API 414 may provide a programmatic interface by which one of the third-party affiliation facilitators 465 can obtain generated reference rewriter code based on provided information about affiliations held by a particular content provider associated with the third-party affiliation facilitator, possibly in exchange for payment. In addition, the AFS API 414 may also provide programmatic interface to a client application utilized by a user to interact with the AFS 410 in various ways. For example, the functionality exposed via the AFS API 414 may support the development of custom applications operating on portable client devices (e.g., smart phones, PDAs, pagers, etc.), custom hardware (e.g., kiosk-based systems), etc.

The transaction manager module 415 provides transaction processing services utilized by content providers 470 and/or target sites 460. Such services may include determining compensation owed by target sites 460, and owed to content providers 470, based on tracked accesses originating with content provided by those content providers. In addition, such services may include transferring, or initiating the transfer of, payments from target sites 460 and/or to content providers 470.

In an example embodiment, modules of the AFS 410 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk), functional (e.g., ML, Lisp, Scheme, etc.), procedural (e.g., C, Pascal, Ada, Modula), scripting (e.g., Perl, Ruby, Python, PHP, ASP, etc.), etc.

One skilled in the art will recognize that the implementation described above uses well-known or proprietary synchronous and/or asynchronous client-server computing techniques. However, any of the AFS modules 411-416 may be implemented using more monolithic programming techniques as well. In addition, programming interfaces to the data stored (e.g., in the AFS data repository 416) as part of the AFS 410 can be available through standard programming techniques such as through C, C++, C#, and Java and through scripting or markup languages such as HTML and/or XML, or through Web servers supporting such. The AFS data repository 416 may be implemented for scalability reasons as a database system rather than as one or more text files, however any method for storing such information may be used. In addition, many of the modules may be implemented as stored procedures operating in the context of a data repository (e.g., a database management system), or methods attached to affiliation facilitation “objects,” although other techniques are equally effective.

The AFS 410 may be implemented in a distributed environment comprising multiple, even heterogeneous, computer systems and networks. For example, in one embodiment, reference rewriter provider module 411, the user/account manager module 412, the access tracker module 413, the AFS API 414, and the transaction manager module 415 are all located in physically different computer systems. In another embodiment, various modules of the AFS 410 are hosted each on a separate server machine and may be remotely located from the tables which are stored in the AFS data repository 416. Different configurations and locations of programs and data are contemplated for use with techniques described herein. A variety of distributed computing techniques are appropriate for implementing the components of the illustrated embodiments in a distributed manner including but not limited to TCP/IP sockets, RPC (“Remote Procedure Call”), RMI (“Remote Method Invocation”), HTTP, Web Services (XML-RPC, JAX-RPC, SOAP, etc.). Also, other functionality could be provided by each module, or existing functionality could be distributed amongst modules in different ways, yet still achieve the functions of the AFS.

FIG. 5 is an example flow diagram of an example reference rewriter provider routine provided by an example embodiment of an Affiliation Facilitator System. The illustrated routine may be provided by, for example, execution of the reference rewriter provider module 411 of the AFS 410, described with reference to FIG. 4. The illustrated routine generates reference rewriter code based on information about affiliations between content providers and target sites. In addition, the illustrated routine provides generated reference rewriter code in response to requests received from, for example, browsers executing on client computing systems 455, content providers 470, and/or third-party affiliation facilitators 465, as described with reference to FIGS. 1-4.

In steps 501-509, the routine performs a loop in which it repeatedly receives and processes a request related to managing reference rewriter code associated with a designated user. Specifically the routine begins at step 501 where it receives a request related to managing reference rewriter code associated with a designated user. The user may be, for example, a content provider that holds one or more affiliations (with corresponding target sites) that are managed by the AFS 410 and/or third-party affiliation facilitators 465, as described with reference to FIG. 4.

In step 502, the routine determines the type of the request. If the request is to provide reference rewriter code, the routine continues with step 503, else if the request is to generate reference rewriter code, the routine continues with step 505, else if the request is of some other type, the routine continues with step 507. A request to provide reference rewriter code will typically be received from an application executing on a client computing system such as a browser, but can also be received from other sources, such as content providers (e.g., who desire to host their own copies of reference rewriter code customized for their content) and/or third-party affiliation facilitators (e.g., who purchase or otherwise obtain authorized copies of reference rewriter code generated for content providers for whom they manage affiliations with target sites).

In step 503, the routine obtains reference rewriter code associated with the designated user. The reference rewriter code may be obtained from, for example, the AFS data repository 416 described with reference to FIG. 4. The reference rewriter code will typically have been automatically generated by this routine, as described with reference to steps 505-506, below.

In step 504, the routine provides the obtained reference rewriter code to the requester. The reference rewriter code may be provided in various ways, such as by sending the reference rewriter code (e.g., source and/or binary instructions/code and/or data) over a network connection to the system that initially provided the received request. After step 504, the routine proceeds to step 508.

In steps 505-506, the routine automatically generates reference rewriter code customized based on affiliations associated with the designated user. Specifically, in step 505, the routine obtains information about affiliations associated with the designated user. The obtained information may include a list of references (e.g., URLS) to target sites along with corresponding references to affiliation facilitators that are responsible for managing affiliations between the designated user and the target sites. The obtained information may further include one or more indications of the designated user (e.g., user/account identifiers) such that affiliation facilitators may appropriately track and record accesses for the benefit of the designated user.

In step 506, the routine generates and stores reference rewriter code that is customized based on the obtained information. Generating the reference rewriter code may include automatically emitting code (e.g., in source and/or binary form) and data configured to, when executed by a client browser, modify links based on the affiliation information obtained in step 505, above. Generating the reference rewriter code may also include other processing steps, such as obfuscating, compiling, preprocessing, linking, and/or packaging the code for transport to, and execution by, client browsers. The generated code may then be stored in, for example, the AFS data repository 416 of FIG. 4. After step 506, the routine proceeds to step 508.

In step 507, the routine performs other types of requests as indicated. Other types of request may include, for example, providing information related to the operation of this routine, such as data about the number of times a particular reference rewriter code module has been generated, obtained, or otherwise utilized, possibly for purposes of obtaining payment for providing reference rewriters (e.g., in cases when this routine generates and provides reference rewriter code to third-party affiliation facilitators, possibly in exchange for payment). After step 507, the routine proceeds to step 508.

In step 508, the routine optionally performs other actions as appropriate. Other actions may include, for example, periodic housekeeping operations such as logging usage, managing logs (e.g., log rotation), etc.

In step 509, the routine determines whether to continue, and, if so continues to step 501 to await further requests, else ends. The routine may determine not to continue under various circumstances, such as by receiving a shutdown instruction (e.g., a request, signal, etc.).

FIG. 6 is an example flow diagram of an example reference rewriter routine generated and provided by an example embodiment of an Affiliation Facilitation System. The illustrated routine may be generated by, for example, execution of the reference rewriter provider module 411 of the AFS 410, described with reference to FIG. 4, e.g., according to the steps of FIG. 5. The illustrated routine may be provided, for example, to be executed on browsers operating on client computing systems 455 in order to automatically modify links having references to designated target sites so that those links refer instead to designated affiliation facilitators, such as AFS 410 and/or third-party affiliation facilitators 465, as described with reference to FIGS. 1-4.

The routine begins at step 601, where it determine a mapping of target site references to corresponding affiliate references. Such a mapping may be represented in various ways, such as hard-coded as literal data provided as part of the Reference Rewriter routine itself, as is illustrated in Tables 2 and 3, above. In other embodiments, such a mapping may be obtained dynamically (e.g., at execution time of this routine), as by requesting a current mapping from a network-accessible source, such as an affiliation facilitator, or by retrieving a current mapping from a local or remote data repository.

In step 602, the routine determines a collection of links from a document being processed (e.g., read, parsed, rendered, etc.) by the browser executing this routine. The collection of links may be determined in various ways, such as by searching or otherwise processing a data structure representing the document (e.g., a DOM tree) and/or by invoking an access function to obtain a previously generated collection of links (e.g., that was generated during the parsing of an HTML or other document). The collection of links may include every link in the document, or some subset thereof (e.g., only links referring to network-accessible documents and not local documents).

In steps 603-606, the routine performs a loop where it iterates over the determined collection of links, and modifies those links that are designated in the mapping obtained in step 601 as having a corresponding affiliation facilitator. In step 603, the routine assigns the next link of the collection of links to a local variable named “currentLink.” In step 604, the routine determines whether currentLink includes one of the target site references in the mapping of target site references to corresponding affiliation facilitators, and if so, continues with step 605, else with step 606. Such a determination may be performed in various ways, such as by string matching, hashing, regular expression matching, etc.

In step 605, the routine modifies the link indicated by currentLink based on the corresponding affiliate reference located in the mapping of target site references to corresponding affiliation facilitators. Such modification may be performed in various ways. For example, as described with reference to Tables 2 and 3, above, the target site reference may be appended to, or concatenated with, a reference to the corresponding affiliation facilitator, with the resulting reference being used to replace the original link reference to the target site. In other embodiments, the described mapping may include instructions for generating a reference to the affiliation facilitator that includes the appropriate arguments (e.g., identification of content provider, target site, etc.) and/or protocol for invoking operation of the affiliation facilitator. Such an approach may provide additional flexibility when multiple, distinct affiliation facilitators utilize different interfaces, calling conventions, or information-passing protocols.

In step 606, the routine determines whether there are more links to process in the collection of links, and if so, proceeds to step 603 in order to continue the loop of steps 603-606, else ends.

All of the above U.S. patents, U.S. patent application publications, U.S. patent applications, foreign patents, foreign patent applications and non-patent publications referred to in this specification and/or listed in the Application Data Sheet are incorporated herein by reference, in their entireties.

From the foregoing it will be appreciated that, although specific embodiments of the invention have been described herein for purposes of illustration, various modifications may be made without deviating from the spirit and scope of the invention. For example, one skilled in the art will recognize that the methods and systems for facilitating affiliation-based transactions discussed herein are applicable to other architectures and topologies other than the Internet and Web browsers. One skilled in the art will also recognize that the methods and systems discussed herein are applicable to differing protocols, communication media (optical, wireless, cable, etc.) and devices (such as wireless handsets, electronic organizers, personal digital assistants, portable email machines, game machines/consoles, entertainment consoles, pagers, navigation devices such as GPS receivers, etc.).

1. A computer-implemented method for facilitating affiliate-based transactions, the method comprising:
receiving a request for a code module, the code module comprising instructions that are configured to execute on a client computing device to cause the client computing device to automatically modify links in a document that refer to designated target sites to refer instead to designated affiliation facilitators, by:
obtaining a link from a content section of the document, the link including a reference to a designated target site; and
automatically modifying the obtained link to include a reference to a designated affiliation facilitator, such that, when the modified link is selected by a user operating the client computing device, a request is forwarded to the designated affiliation facilitator instead of the designated target site; and
providing an indication of the code module.

2. The method of claim 1 wherein the designated target site is at least one of an online store, a Web merchant, an advertiser, a media provider, or a content provider.

3. The method of claim 1 wherein the method is performed by the designated affiliation facilitator.

4. The method of claim 1 wherein the method is performed by a computing system operated by an entity that does not operate an affiliation facilitator.

5. The method of claim 1 wherein the method is performed in exchange for payment received from at least one of an affiliation facilitator, a target site, a content provider.

6. The method of claim 1 wherein the document is associated with a content provider that provides documents to client computing devices in response to requests received from the client computing devices.

7. The method of claim 1 wherein the document is associated with a content provider that generates documents that are configured to be displayed on client computing devices.

8. The method of claim 1, further comprising:
receiving the request that is forwarded to the designated affiliation facilitator;
tracking an access to the designated target site based on the request that is forwarded to the designated affiliation facilitator; and
forwarding a request to the designated target site based on the request that is forwarded to the designated affiliation facilitator.

9. The method of claim 1 wherein the request that is forwarded to the designated affiliation facilitator is an HTTP request that includes an indication of the designated target site and an indication of a content provider associated with the document.

10. The method of claim 1, further comprising automatically generating the code module based upon information about an affiliation between a content provider associated with the document and the designated target site, the information including an indication of the designated target site and an indication of the designated affiliation facilitator.

11. The method of claim 1, further comprising initiating execution of the code module by providing the code module to a client module executing on the client computing device in response to a request for the document, the request received from the client module.

12. The method of claim 1 wherein the code module includes JavaScript instructions.

13. The method of claim 1 wherein the code module includes at least one of ActionScript instructions, VBScript instructions, Java instructions, Java Virtual machine instructions, Visual Basic instructions, or Common Language Runtime instructions.

14. The method of claim 1 wherein the obtaining of the link from the content section of the document includes accessing a data structure representing the document, the data structure resident in a memory of the client computing device.

15. The method of claim 14 wherein the modifying of the obtained link includes modifying one or more elements of the data structure representing the document.

16. The method of claim 1 wherein the modifying of the obtained link includes altering the link to refer to the designated affiliation facilitator and to pass the reference to the designated target site to the designated affiliation facilitator.

17. The method of claim 1 wherein the modifying of the obtained link includes altering the link to refer to the designated affiliation facilitator and to indicate a content provider associated with the document to the designated affiliation facilitator.

18. The method of claim 1 wherein the document includes data and/or instructions in a content presentation language.

19. The method of claim 18 wherein the content presentation language is HTML, and wherein the document includes HTML instructions and an HTML SCRIPT element that includes an indication of the code module.

20. The method of claim 1 wherein the client computing device is executing a client presentation application configured to process markup language instructions.

21. The method of claim 1 wherein the reference to the target site is designated by a Uniform Resource Locator (URL) and/or Uniform Resource Identifier (URI).

22. A computer-readable medium whose contents enable a computing system to facilitate affiliate-based transactions, by performing a method comprising:
receiving a request for a code module, the code module comprising instructions that are configured to cause a client module to automatically modify links in a content unit that refer to designated target sites to indicate designated access trackers, by:
obtaining a link from a content section of the content unit, the link including a reference to a designated target site; and
automatically modifying the obtained link to include a reference to a designated access tracker, such that, when the modified link is processed by the client module, a request is forwarded to the designated access tracker; and
providing an indication of the code module.

23. The computer-readable medium of claim 22 wherein the computer-readable medium is at least one of a memory in a computing device or a data transmission medium transmitting a generated signal containing the contents.

24. The computer-readable medium of claim 22 wherein the contents are instructions that when executed cause the computing system to perform the method.

25. The computer-readable medium of claim 22 wherein the client module is a Web browser executing on a computing system that is at least one of a desktop computer, a laptop computer, a smart phone, a cellular phone, a gaming console, or a personal digital assistant.

26. The computer-readable medium of claim 22 wherein the content unit is at least one of a document, a file, a page, or a stream.

27. The computer readable medium of claim 22 wherein the designated access tracker is the designated target site, and wherein the designated access tracker is configured to periodically provide information about tracked accesses to an affiliation facilitator.

28. The computer readable medium of claim 22 wherein the designated access tracker is distinct from the designated target site, and wherein the access tracker is configured to process the request that is forwarded to the designated access tracker by recording the request and forwarding the request to the designated target site.

29. A computing system configured to facilitate affiliate-based transactions, comprising:
a memory;
a module stored on the memory that is configured to, when executed:
receive a request for a code module, the code module comprising instructions that are configured to execute on a client computing system to cause the client computing system to automatically modify links in a document that refer to designated target sites to refer instead to designated tracking modules, by:
obtaining a link from a content section of the document, the link including a reference to a designated target site; and
automatically altering the obtained link to include a reference to a designated tracking module, such that, when the link is selected by operating the client computing system, a request is forwarded to the designated tracking module instead of the designated target site; and
provide an indication of the code module.

30. The computing system of claim 29 wherein the module includes software instructions for execution in the memory of the computing system.

31. The computing system of claim 29 wherein the module is a reference rewriter provider module.

32. The computing system of claim 29 wherein the module is part of an affiliation facilitator system configured to provide affiliation management services to content providers and/or target sites.

33. The computing system of claim 29, further comprising the designated tracking module.

34. The computing system of claim 29 wherein the designated tracking module is configured to track accesses to the designated target site by receiving the request that is forwarded to the designated tracking module and, based on the received request, recording an access to the designated target site.

35. The computing system of claim 29 wherein the designated tracking module is configured to:
forward accesses to the designated target site by receiving the request that is forwarded to the designated tracking module; and,
based on the received request, forward a request to the designated target site.

36. The computing system of claim 35 wherein the request received by the designated tracking module is an HTTP request from the client computing system, the HTTP request including an indication of the designated target site, and wherein the request forwarded to the designated target site is an HTTP response to the client computing system, the HTTP response including a redirection code.

37. The computing system of claim 29 wherein the designated tracking module and wherein forwarding the request to the designated target site includes providing an HTTP redirect response to a client browser executing on the designated client computing device.

38. The computing system of claim 29 wherein the forwarded request includes an indication of the designated target site and of a content provider associated with the document.

39. The computing system of claim 29, further comprising a second module stored on the memory that is configured to, when executed, provide payment to a content provider based upon accesses to the designated target site tracked by the designated tracking module.

40. A computer-readable medium containing a data structure for use in facilitating affiliate-based transactions, the data structure comprising:
a content section comprising content displayable by a computing system and one or more links each having a reference to a designated target site; and
a code section indicating instructions that are configured to, when executed by the computing system, cause the computing system to automatically modify each of the one or more links to include a reference to a designated access tracker, such that, when the link is selected, the computing system forwards a request to the designated access tracker instead of the designated target site.

41. The computer-readable medium of claim 40 wherein the data structure is based on HTML data provided by a content provider, the content section is based on a body element of the HTML data, and the code section is based on a script element of the HTML data.

42. The computer-readable medium of claim 40 wherein the data structure is provided by a content provider that has an affiliate relationship with each of the designated target sites and/or a content provider that has a relationship with another entity that has an affiliate relationship with each of the designated target sites.

43. The computer-readable medium of claim 40 wherein the access tracker is provided by an affiliation facilitator system that manages affiliations between content providers and at least some of the designated target sites.
